(19) United States
(12) Patent Application Publication
(10) Pub. No.: US 2002/0031637 A1
(43) Pub. Date: Mar. 14, 2002

(54) Molded cushion element and method for production thereof

(76) Inventors: Louis Oborny, North Aurora, IL (US); James Tran, Overland Park, KS (US); James Curtin, Kearney, MO (US); Leslie E. Clark, Cambridge (CA)

Correspondence Address: PATENT ADMINSTRATOR, KATTEN MUCHIN ZAVIS, SUITE 1600, 525 WEST MONROE STREET, CHICAGO, IL, 60661, US

(21) Appl. No.: 09/905,665

(22) Filed: Jul. 16, 2001

Related U.S. Application Data
(60) Provisional application No. 60/218,175, filed on Jul. 14, 2000.

(51) Int. Cl. B32B 23/02; B29C 44/12

(52) U.S. Cl. 428/99; 428/192; 264/415; 264/46.4

(57) ABSTRACT

There is a described a cushion element a method for producing same. Specifically, the improved cushion element includes a fastener assembly for mechanical adhesion of a trim cover to the cushion element. The fastener assembly comprises laterally spaced marginal portions which extend longitudinally along the fastener assembly. These margins are embedded in or encompassed by the foam body thereby improving the mechanical “pull-out” strength of the fastener assembly in the foam body.

### CROSS-REFERENCE TO RELATED APPLICATION

The present application claims the benefit under 35 U.S.C. §119(e) of provisional patent application Ser. No. 60/218,175, filed Jul. 14, 2000, the contents of which are hereby incorporated by reference.

### BACKGROUND OF THE INVENTION

1. Field of the Invention

In one of its aspects, the present invention relates to a molded cushion element. In another of its aspects, the present invention relates to a method for production of a molded cushion element.

2. Description of the Art

In the art of adhering cover materials to cushion elements, it is known to utilize a mechanical fastener assembly to adhere a cover material to a cushion element.

One particular class of cushion elements comprises isocyanate-based polymer foams. Isocyanate-based polymer foams are known in the art. Generally, those of skill in the art understand isocyanate-based polymer foams to be polyurethane foams, polyurea foams, polyisocyanurate foams and mixtures thereof.

It is also known in the art to produce isocyanate-based polymer foams by a variety of techniques. Indeed, one of the advantages of isocyanate-based polymers compared to other polymer systems is that polymerization and foaming can occur in situ. This results in the ability to mold the polymer while it is forming and expanding.

One of the conventional ways to produce an isocyanate-based polymer foam, such as a polyurethane foam, is known as the “one-shot” technique. In this technique, the isocyanate, a suitable polyol, a catalyst, water (which acts as a reactive blowing agent and can optionally be supplemented with one or more blowing agents) and other additives are mixed together at once in a suitable mixer to produce a liquid foamable composition. The liquid foamable composition and is then expanded and/or molded to produce polyurethane foam. Generally, if one were to produce a polyurea, the polyol would be replaced with a suitable polyamine. A polyisocyanurate may result from cyclotrimerization of the isocyanate component. Urethane-modified polyurea foam or polyisocyanurate foam are known in the art. In either scenario, the reactants would be intimately mixed very quickly using a suitable mixer.

When it is desired to utilize a mechanical fastener to adhere a cover material to the isocyanate-based polymer foam, it is known to place the mechanical fastener in the mold such that it is molded into the finished foam product. Generally, a conventional mechanical fastener comprises a touch fastening surface. As used throughout this specification, the term “touch fastening surface” is intended to mean a surface which will adhere to a complementary surface on the cover material to be adhered to the cushion element. Practically, the touch fastening surface has taken the form of one half of a “hook and loop” fastener system. In other words the touch fastening surface comprises a plurality of hook elements and the cover material comprises a plurality of loop elements, or vice versa, such that the hook elements and loop elements mechanically engage one another when pressed into contact. Generally, it has been preferred to have the hook elements on the mechanical fastener molded in the cushion element and the loop elements on the cover material to be adhered to the cushion element.

Conventionally, the mechanical fastener is placed in the mold such that the touch fastening surface is flush against a surface of the mold (usually the mold surface is provided with a trench for receiving the touch fastening surface of the mechanical fastener)—i.e., such that a touch fastening surface is exposed in the finished foam product. When utilizing such a mechanical fastener in a mold for production of an isocyanate-based polymer foam, specific care must be taken to avoid fouling of the touch fastening surface of the mechanical fastener with the liquid foamable composition which is dispensed into the mold. Fouling of the touch fastening surface can occur as a result of the liquid nature of the foamable composition, together with the generally above-ambient pressure conditions within the mold.

Thus, much attention in the prior art has been devoted to development of mechanical fasteners which are designed to obviate or mitigate fouling of the touch fastening surface by ingress of the liquid foamable composition. See, for example, any one of the following:

U.S. Pat. No. 4,470,857 [Casalou];

U.S. Pat. No. 4,563,380 [Black et al.];

U.S. Pat. No. 4,617,214 [Billarant];

U.S. Pat. No. 4,693,921 [Billarant];

U.S. Pat. No. 4,710,414 [Northrup et al.];

U.S. Pat. No. 4,726,975 [Hatch];

U.S. Pat. No. 4,784,890 [Black]

U.S. Pat. No. 4,802,939 [Billarant];

U.S. Pat. No. 4,814,036 [Hatch];

U.S. Pat. No. 4,842,916 [Ogawa et al.]

U.S. Pat. No. 4,933,035 [Billarant];

U.S. Pat. No. 5,171,395 [Gilcreast];

U.S. Pat. No. 5,688,576 [Ohno et al.]; and

U.S. Pat. No. 5,972,465 [Ohno et al.].

As will be apparent to those of skill in the art, it is important to avoid fouling of the touch fastening surface by ingress of the liquid foamable composition to maximize mechanical adhesion between the two surfaces of the mechanical fastener. Even if this can be achieved, there are limitations to the prior art approach.

Specifically, it is generally accepted in the art that a minimal surface area of touch fastener surface should be used to achieve sufficient mechanical adhesion of the trim cover to the foam part. This is especially the case when producing polyurethane foam seating components. In practice, this has translated into use of a fastener having a width of 24 mm in a trench in the mold, the trench having a width of 24 mm-28 mm.

As is known in the art, polyurethane foam seating elements comprise a so-called A-surface, i.e., the exposed surface which is contacted by the occupant. In recent years, it has been conventional to design such polyurethane foam seating elements to be functional (i.e., acceptable balance of stiffness and resiliency) while being aesthetically appealing. One approach to creating aesthetic appeal in the A-surface of a polyurethane foam seating element is to design channels or trenches in the A-surface which follow contours in that surface.

Unfortunately, the use of a 24 mm wide mechanical wide fastener such as that described above typically results in the creation of a similarly wide trench in the final part which is visually unappealing. Unfortunately, it is not possible to simply narrow the width of the mechanical fastener to produce an aesthetically appealing trench since mechanical adhesion of the trim cover to the foam element (also referred to as pull out strength) will be at least somewhat compromised.

Thus, despite the advances made in the art, it would be desirable to have a system for achieving mechanical adhesion of a trim cover to a foam element resulting in the production of a relatively narrow trench in the A-surface of the finish part without deleteriously compromising mechanical adhesion between the trim cover and the foam part.

### SUMMARY OF THE INVENTION

It is an object of the present invention to provide a novel method for production of a cushion element which obviates or mitigates at least one of the foregoing disadvantages of the prior art.

It is an object of the present invention to provide a novel cushion element which obviates or mitigates at least one of the foregoing disadvantages of the prior art.

Accordingly, in one of its aspects, the present invention provides a method for production of a cushion element in a mold having a mold cavity, the mold comprising a trench for receiving an elongate fastener assembly having a fastening surface (preferably a touch fastening surface) bounded by a pair of longitudinally extending margins, the method comprising the steps of:

(i) placing the fastener assembly in the mold;

(ii) juxtaposing the fastening surface and the trench;

(iii) dispensing a liquid foamable composition in the mold;

(iv) substantially encompassing the margins with the liquid foamable composition; and

(v) expanding the liquid foamable composition to fill substantially the mold cavity to produce the cushion element.

In another of its aspects, the present invention provides a cushion element comprising a foam body portion and a surface having disposed thereon an elongate fastener assembly, the elongate fastener assembly having a fastening surface (preferably a touch fastening surface) bounded by a pair of longitudinally extending margins, at least a portion of the longitudinally extending margins be substantially completely encompassed by the foam body portion.

Thus, the present inventors have discovered that it is possible to utilize a mechanical fastener having a touch fastening surface in a relatively narrow trench in the finished foam cushion element while maintaining an acceptable degree of mechanical adhesion of a trim cover to the foam cushion element. This may be achieved by designing the fastener element to be molded into the cushion element to have marginal sections at least a portion of which are embedded in or encompassed by the foam body into which the fastener assembly is being molded. This additional degree of mechanical locking of the fastener element with respect to the foam body results in improved “pull-out strength” of the fastener assembly while maintaining a useful degree of mechanical adhesion between the fastener assembly and the trim cover.

Thus, a general advantage of the present invention is that a specified pull-out strength for the finished part can be achieved using a thinner width fastener assembly thereby producing a part having a narrower, more visually-appealing trench or channel. Practically, this means that the conventional minimal width of 24 mm for the fastener assembly can be reduced to 18 mm (or even less) allowing the production of a finished part having relatively narrow, aesthetically appealing trenches molded in the A-surface of the cushion element.

Of course, other advantages will be apparent to those of skill in the art.

### BRIEF DESCRIPTION OF THE DRAWINGS

Embodiments of the present invention will be described with reference to the accompanying drawings, wherein like numerals designate like elements, and in which:

FIG. 1 illustrates an enlarged perspective view of a step in the present method;

FIG. 2 illustrates another step of the present method;

FIG. 3 illustrates a cross-sectional view of a portion of a first embodiment of the present cushion element;

FIG. 4 illustrates a perspective view of the present cushion element as applied to a passenger seat;

FIG. 5 illustrates an enlarged view in partial section of a portion of the seat illustrated in FIG. 4;

FIG. 6 illustrates a step in the present method using an alternate fastener assembly to the one illustrated in FIG. 1-3; and

FIG. 7 illustrates an enlarged perspective view of a cushion element, and partial section, produced using a method including the step illustrated in FIG. 6.

### DETAILED DESCRIPTION OF THE PREFERRED EMBODIMENTS

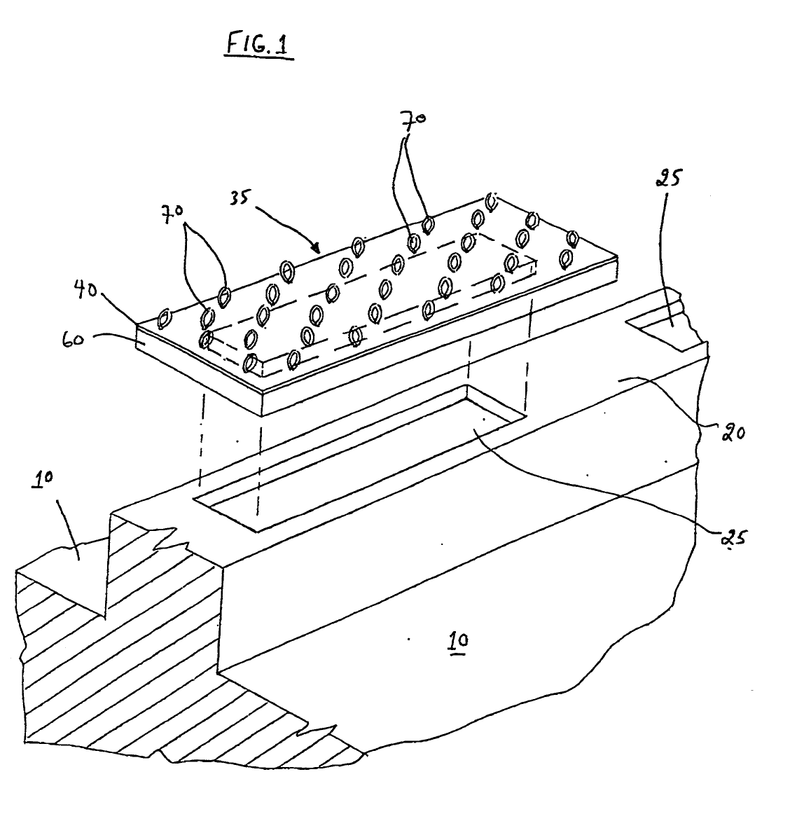

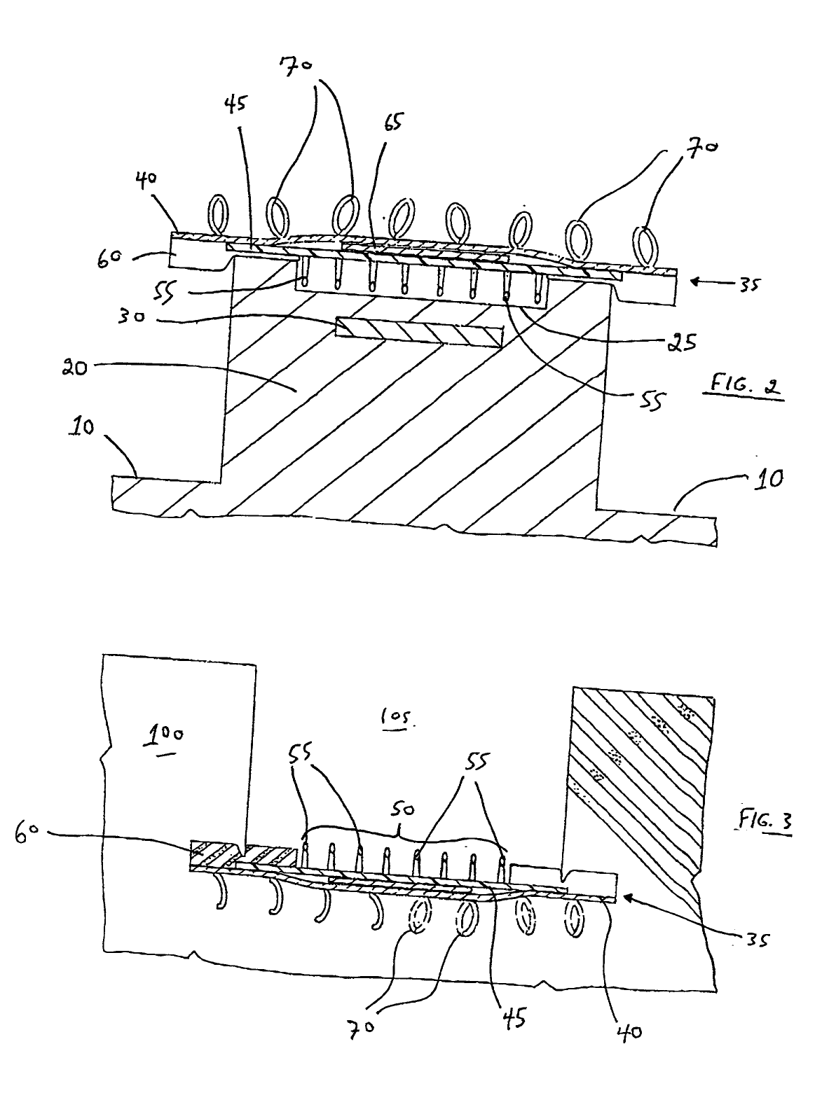

With reference to FIGS. 1-2, there is illustrated a portion of a mold comprising a surface 10. In practice, surface 10 would be a portion of the mold cavity, preferably such a mold cavity being formed by combination of a bowl (not shown) and a lid (not shown). The provision of such molds is conventional in the art.

Preferably, surface 10 is that of the bowl of the mold. In a preferred environment, this surface corresponds to the A-surface of the part to be produced.

As illustrated, disposed on surface 10 is a ridge 20. As will be appreciated by those of skill in the art, ridge 20 serves to mold into the finished part a correspondingly shaped trench which, as will be discussed later, is the relatively narrow, aesthetically appealing trench to be formed in the finished foam cushion foam element.

As shown, ridge 20 comprises a trench 25 disposed in the upper surface thereof.

With reference to FIG. 2, ridge 20 further comprises a magnet 30 disposed in substantial alignment with trench 25.

An initial step in the present method involves placement of a fastener assembly 35 on ridge 20. Thus, fastener assembly 35 comprises a backing layer 40 and fastening layer 45. Fastening layer 45 comprises a touch fastening surface 50 which comprises a plurality of hook members 55. Hook members 55 are spaced inwardly from the combined edges of backing layer 40 and 45. Disposed in the margin defined by this spacing is a foam seal element 60 of a type similar to that described in U.S. Pat. No. 5,766,723 [Oborny et al.]. The preferred seal element comprises polyurethane foam. Further, the preferred such foam seal element comprises an Indentation Force Deflection, when measured pursuant to ASTM D3574-95 (50 in² deflector; 20″×20″×4″ sample size), in the range of from about 10 to about 1000 pounds·force, more preferably from about 10 to about 500 pounds·force, even more preferably from about 10 to about 250 pounds·force, most preferably from about 30 to about 100 pounds·force.

Sandwiched between backing layer 40 and fastening layer 45 is a magnetically attractable strip 65. Disposed on backing layer 40 of the fastener assembly 35 are a number of loop members 70.

With reference to FIGS. 1 and 2, fastener assembly 35 is placed on ridge 20 such that hook members 55 of fastener assembly 35 are disposed in trench 25. When fastener assembly 35 is disposed in the vicinity of trench 25, magnet 30 serves to attract magnetically attractable strip 65 in fastener assembly 35. This attraction causes compression of a portion of foam seat element 60 disposed in the margins of fastener assembly 35. This compression serves to provide an advantageous seal against ingress of foam material into trench 25 thereby fouling hook members 55.

As particularly illustrated FIG. 2, opposed portions of foam seal element 60, together with adjacent portions of backing layer 40 overhang ridge 20.

Thereafter, a liquid foamable composition (not shown) is dispensed in the bowl (not shown) of the mold in a conventional manner. It is preferred, that during dispensing of the liquid foamable composition, the lid and bowl of the mold are disengaged. After dispensing the liquid foamable composition, it is preferred to engage the bowl and the lid thereby defining the mold cavity. As will be appreciated by those of skill in the art, as the liquid foamable composition expands, it will encompass the overhanging portions of backing layer 40/foam seal element 60. During expansion of the liquid foamable composition, it is preferred that the composition penetrate the cellular matrix of foam seal element 60 thereby densifying the latter. This serves to enhance the seal formed by foam seal element 60.

With reference to FIG. 3, there is illustrated a portion of the foam cushion member product produced from step 2 (as will be apparent to those of skill in the art), the product in FIG. 3 has been demolded and turned over). As shown in FIG. 3, fastener assembly 35 has been mechanically adhered to a foam body 100. Foam body 100 comprises a trench of channel 105, at the bottom of which is mechanically adhered fastener assembly 35. It is the width of trench or channel 105 which can be significantly reduced using the present method without significantly compromising the pull-out strength of fastener assembly 35. This achieved by embedding or encompassing lateral marginal portions of fastener assembly 35 in foam body 100. The cushion element illustrated in FIG. 3 may then be covered in a conventional manner with a trim cover having appropriately positioned complimentary touch fastening surfaces which will mechanically adhere the trim cover to touch fastening surface 50. In the illustrated example, the complimentary surface of the trim cover would comprise loops which would serve to mechanically adhered the trim cover to hook members 55 of fastener assembly 35.

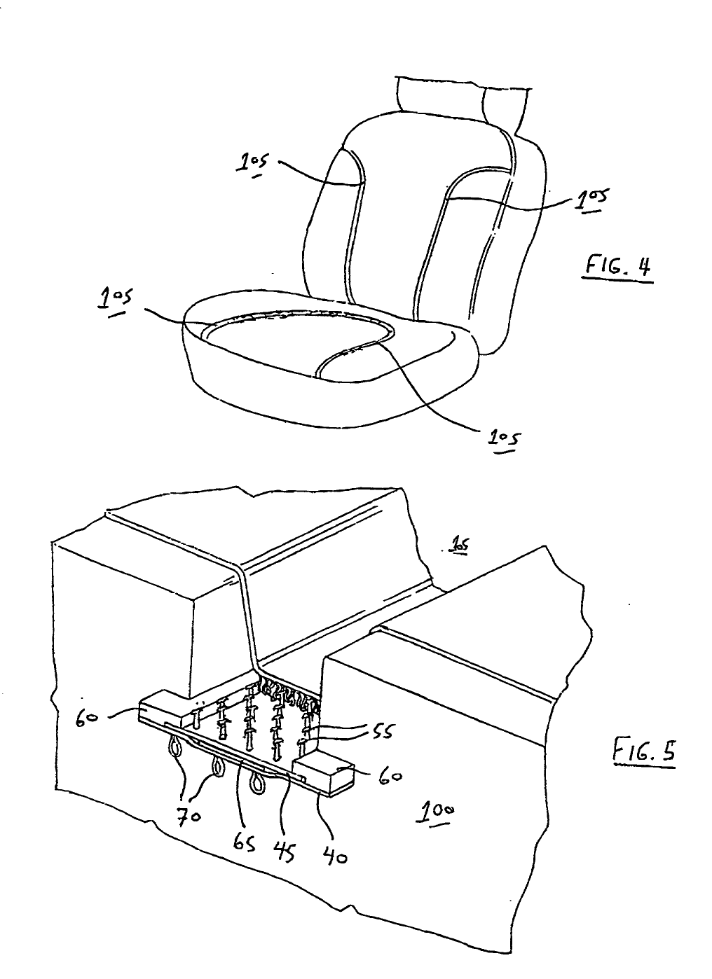

A preferred application of this approach is illustrated in FIG. 4, which shows a passenger seat covered with a trim cover having incorporated therein trenches or channels ways 105. It is along these trenches or passageways 105 that mechanical adhesion is achieved of the trim cover to the product illustrated in FIG. 3.

With reference to FIG. 5, the adhesion of the trim cover in FIG. 4 to the product of FIG. 3 is illustrated. The theme reference numerals correspond to like elements in the previous Figures.

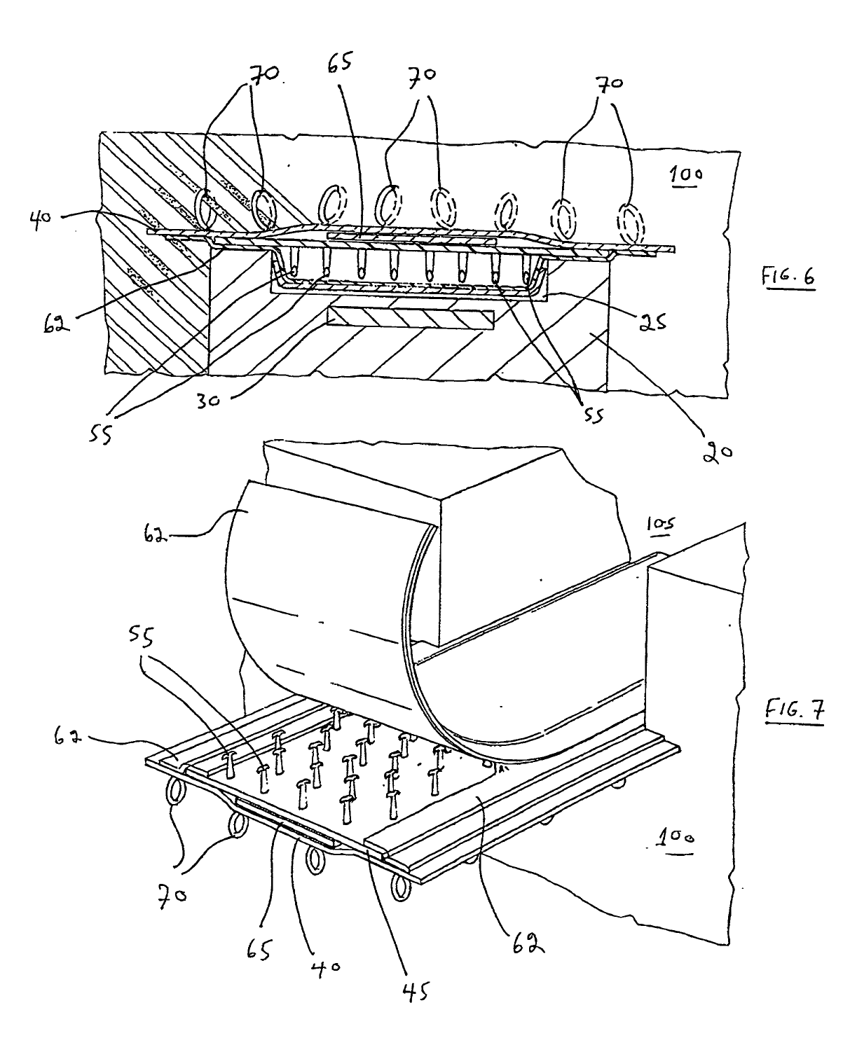

With reference to FIG. 6 and 7, there is illustrated an alternate embodiment of the present method and cushion element. Specifically, in the embodiment illustrated in FIGS. 6 and 7, this is made of a so-called “taped” fastener assembly wherein a removable, impermeable cover layer 62 is used in place of foam seal element 60 referred in FIGS. 1-5. The approach is otherwise very similar to that described above with respect to FIGS. 1-5. As shown in FIG. 7, once the foam cushion element has been produced (note the embedded lateral march and of fastener assembly 35 which are embedded in foam body 100), covering layer 62 is simply removed by tearing it away from fastener assembly 35 thereby exposing hook members 55 which are now ready to be adhered to the trim cover (not shown).

While this invention has been described with reference to illustrative embodiments and examples, the description is not intended to be construed in a limiting sense. For example, while the present method and cushion element have been exemplified with reference to a planar or flat fastener assembly, it is equally and, in some cases, more preferable, to utilize a non-planar fastener assembly such as the one taught in U.S. Pat. Nos. 5,688,576 and 5,972,465 [both to Ohno et al. (Ohno)]. The Ohno faster comprises a planar fastening surface bounded by a pair of longitudinally extending margins (or wings) which are bent with respect to the planar fastening surface. Those of skill in the art will recognize that Ohno fastener may be used in accordance with the present method such that at least a portion (preferably the distal portion) of the bent “wings” or “ridges” are disposed in the mold cavity such that they are encompassed by the liquid foamable composition. In a further modification of the present method, it is possible to orient the fastener assembly such that the end marginal portions thereof (e.g., those which connect the longitudinal extending margins) are encompassed by the liquid foamable composition. For example, this may be achieved by designing ridge 20 to have a top surface area less than the surface area of the fastener assembly so that a perimeter margin portion of the fastener overhangs the ridge thereby allowing the liquid foamable composition to encompass a perimeter portion of the fastener assembly. Thus, various modifications of the illustrative embodiments, as well as other embodiments of the invention, will be apparent to persons skilled in the art upon reference to this description. It is therefore contemplated that the appended claims will cover any such modifications or embodiments.

All publications, patents and patent applications referred to herein are incorporated by reference in their entirety to the same extent as if each individual publication, patent or patent application was specifically and individually indicated to be incorporated by reference in its entirety.

What is claimed is:

1. A method for production of a cushion element in a mold having a mold cavity, the mold comprising a trench for receiving an elongate fastener assembly having a fastening surface bounded by a pair of longitudinally extending margins, the method comprising the steps of:
(i) placing the fastener assembly in the mold;
(ii) juxtaposing the fastening surface and the trench;
(iii) dispensing a liquid foamable composition in the mold;
(iv) substantially encompassing the margins with the liquid foamable composition; and
(v) expanding the liquid foamable composition to fill substantially the mold cavity to produce the cushion element.

2. The method defined in claim 1, wherein the mold comprises a bowl and a lid engageable to define the mold cavity, and Step (i) comprises placing the fastener assembly in the bowl.

3. The method defined in claim 2, wherein the bowl and the lid are disengaged during Step (iii).

4. The method defined in claim 2, wherein the bowl and the lid are engaged after Step (iii).

5. The method defined in claim 1, wherein the margins are substantially free of fastening surface.

6. The method defined in claim 1, wherein Step (ii) further comprises securing the fastener assembly with respect to the trench.

7. The method defined in claim 6, wherein the mold comprises a magnet disposed adjacent the trench and Step (ii) further comprises magnetically securing the fastener assembly with respect to the trench.

8. The method defined in claim 1, wherein each of the margins comprise a foam seal element.

9. The method defined in claim 8, wherein Step (ii) further comprises magnetically compressing the fastener assembly thereby compressing the foam seal element.

10. The method defined in claim 8, wherein Step (ii) further comprises magnetically compressing the fastener assembly thereby compressing the a first portion of the foam seal element.

11. The method defined in claim 10, wherein Step (iv) comprises contacting an uncompressed, section portion of the foam seal element with the liquid foamable composition.

12. The method defined in claim 11, wherein said contacting causes densification of the foam seal element.

13. The method defined in claim 11, wherein the foam seal element has an Indentation Force Deflection, when measured pursuant to ASTM D3574-95 in the range of from about 10 to about 1000 pounds·force.

14. The method defined in claim 11, wherein the foam seal element has an Indentation Force Deflection in the range of from about 10 to about 500 pounds·force.

15. The method defined in claim 11, wherein the foam seal element has an Indentation Force Deflection in the range of from about 10 to about 250 pounds·force.

16. The method defined in claim 11, wherein the foam seal element has an Indentation Force Deflection in the range of from about 30 to about 100 pounds·force.

17. The method defined in claim 11, wherein the foam seal element comprises a polyurethane foam.

18. The method defined in claim 1, wherein the fastener assembly comprises a cover layer which substantially completely covers the fastening surface.

19. The method defined in claim 18, wherein the cover layer is adhered to the margins.

20. The method defined in claim 1, wherein Step (i) comprises placing the fastener assembly on a raised platform disposed in the mold cavity, at least a portion of each margin extending over an edge of the platform.

21. A cushion element comprising a foam body portion and a surface having disposed thereon an elongate fastener assembly, the elongate fastener assembly having a fastening surface bounded by a pair of longitudinally extending margins, at least a portion of the longitudinally extending margins be substantially completely encompassed by the foam body portion.

22. The cushion element defined in claim 21, wherein the margins are substantially free of fastening surface.

23. The cushion element defined in claim 21, wherein the fastener assembly further comprises a magnetically attractable element.

24. The cushion element defined in claim 23, wherein the magnetically attractable element is disposed substantially longitudinally with respect to the fastener assembly.

25. The cushion element defined in claim 21, wherein each of the margins comprise a foam seal element.

26. The cushion element defined in claim 25, wherein the foam seal element comprises a first portion encompassed by the foam body and a second portion non-encompassed by the foam body.

27. The cushion element defined in claim 25, wherein the first portion has a higher density than the second portion.

28. The cushion element defined in claim 25, wherein the foam seal element has an Indentation Force Deflection, when measured pursuant to ASTM D3574-95 in the range of from about 10 to about 1000 pounds·force.

29. The cushion element defined in claim 25, wherein the foam seal element has an Indentation Force Deflection in the range of from about 10 to about 500 pounds·force.

30. The cushion element defined in claim 25, wherein the foam seal element has an Indentation Force Deflection in the range of from about 10 to about 250 pounds·force.

31. The cushion element defined in claim 25, wherein the foam seal element has an Indentation Force Deflection in the range of from about 30 to about 100 pounds·force.

32. The cushion element defined in claim 25, wherein the foam seal element comprises a polyurethane foam.

33. The cushion element defined in claim 21, wherein the fastener assembly comprises a cover layer which substantially completely covers the fastening surface.

34. The cushion element defined in claim 33, wherein the cover layer is adhered to the margins.

35. The cushion element defined in claim 21, wherein the fastener is disposed in a channel formed in the surface of the cushion element.
